(19) United States
(12) Patent Application Publication
(10) Pub. No.: US 2025/0148935 A1
(43) Pub. Date: May 8, 2025

(54) HUMAN BODY MODEL

(71) Applicant: ASAHI INTECC CO., LTD., Seto-shi (JP)

(72) Inventor: Kazu TAKEMURA, Seto-shi (JP)

(73) Assignee: ASAHI INTECC CO., LTD., Seto-shi (JP)

(21) Appl. No.: 18/938,805

(22) Filed: Nov. 6, 2024

(30) Foreign Application Priority Data
Nov. 7, 2023 (JP) 2023-189832

(51) Int. Cl. G09B 23/28

(52) U.S. Cl. CPC G09B 23/286

(57) ABSTRACT

A human body model is provided that includes a blood vessel model simulating a blood vessel of a human body and a tissue model disposed around the blood vessel model, the tissue model simulating a tissue around the blood vessel. A plurality of bubbles is dispersed between a surface of the tissue model (an outermost surface of the human body model) and the blood vessel model.

### CROSS-REFERENCE TO RELATED APPLICATIONS

This application claims priority from Japanese Patent Application No. 2023-189832 filed Nov. 7, 2023, the contents of the prior application being incorporated herein by reference in its entirety.

### BACKGROUND

The present disclosure relates to a human body model.

A procedure (EVUS guide: Extravascular Ultrasound Guide) is known in which therapy is performed while inserting a medical device, such as a catheter, into a blood vessel by using an ultrasonic image diagnostic apparatus. This procedure is advantageous in that there is no exposure to radiation such as X-rays, and that, for example, a behavior of the medical device inserted into a body can be confirmed in real time.

In order to learn the above-described procedure, for example, training may be performed by using a “human body model.” Such a human body model, for example, may be a human body model that has a tactile sensation and hardness that closely resembles those of a human body and that provides an echo image in which subcutaneous tissue can be visually recognized has been proposed according to International Publication No. WO2018/034074.

### SUMMARY

However, in the conventional human body model as described above, since ultrasonic waves are reflected by aluminum oxide dispersed in a gel-like simulated subcutaneous tissue, an echo image of the entire site where the aluminum oxide is dispersed appears excessively white (bright) on a monitor, and tends to be different from an echo image of an actual human body containing a large amount of water in the subcutaneous tissue.

The disclosed embodiments have been made based on the above circumstances, and an object of the disclosed embodiments is to provide a human body model capable of acquiring an ultrasonic echo image that more closely resembles a human body, for example, when EVUS guide is performed.

To achieve the above object, the present disclosure includes a human body model including a blood vessel model that simulates a blood vessel of a human body, and a tissue model that is arranged around the blood vessel model and that simulates a tissue around the blood vessel. A plurality of bubbles are dispersedly arranged between a surface of the tissue model and the blood vessel model; and a human body model including a lower layer including a blood vessel model that simulates a blood vessel of a human body and a first tissue model that is arranged around the blood vessel model and that simulates a tissue around the blood vessel, and an upper layer provided on the lower layer and including a second tissue model, in which a plurality of bubbles are dispersedly arranged in at least one of an inside of the upper layer, a boundary portion between the upper layer and the lower layer, and an inside of the lower layer.

### BRIEF DESCRIPTION OF THE DRAWINGS

FIG. 1 is a schematic sectional view illustrating an embodiment of the disclosed embodiments.

FIG. 2 is a schematic sectional view illustrating an embodiment of the disclosed embodiments.

FIG. 3A is a schematic sectional view illustrating an embodiment of the disclosed embodiments.

FIG. 3B is a schematic sectional view illustrating an embodiment of the disclosed embodiments.

FIG. 4 is a schematic sectional view illustrating an embodiment of the disclosed embodiments.

FIG. 5 is a schematic sectional view illustrating an embodiment of the disclosed embodiments.

FIG. 6 is a schematic sectional view illustrating an embodiment of the disclosed embodiments.

FIG. 7 is a schematic sectional view illustrating an embodiment of the disclosed embodiments.

### DETAILED DESCRIPTION

In some embodiments, a human body model according to the present disclosure may refer to a human body model including: a blood vessel model that simulates a blood vessel of a human body; and a tissue model that is arranged around the blood vessel model. The tissue model simulates a tissue around the blood vessel. A plurality of bubbles are dispersedly arranged between a surface of the tissue model and the blood vessel model.

The present disclosure also includes a human body model including: a lower layer including a blood vessel model that simulates a blood vessel of a human body and a first tissue model that is arranged around the blood vessel model and that simulates a tissue around the blood vessel; and an upper layer provided on the lower layer and including a second tissue model, in which a plurality of bubbles are dispersedly arranged in at least one of an inside of the upper layer, a boundary portion between the upper layer and the lower layer, and an inside of the lower layer. In the present disclosure, a “deep portion” means a site of the human body model closer to the blood vessel model than the plurality of bubbles (also referred to as a “bubble group”). In addition, the “outermost surface” means a surface of the human body model which is positioned on a side opposite to a side of the blood vessel model across a plurality of bubbles (bubble group), and which is positioned in a site farthest from the blood vessel model and faces outside.

The “outermost surface” may be a flat surface or a curved surface.

Hereinafter, some embodiments of the present disclosure will be described with reference to the drawings, but the present disclosure is not limited only to the embodiments illustrated in the drawings. Furthermore, dimensions of each part illustrated in the drawings are dimensions illustrated to facilitate understanding of contents of implementation, and do not necessarily correspond to the actual dimensions.

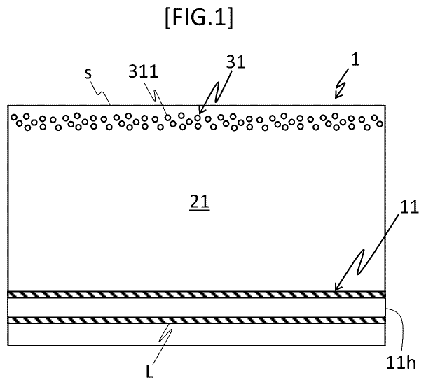

FIG. 1 is a schematic sectional view illustrating an embodiment of the disclosed embodiments. As illustrated in FIG. 1, a human body model 1 schematically includes a blood vessel model 11, a tissue model 21, and a plurality of bubbles 31.

The blood vessel model 11 is a site that simulates a blood vessel of a human body. The blood vessel model 11 may have a branch portion or a curved portion. To be specific, the blood vessel model 11 may be constituted of, for example, a tubular member having an inner cavity 11h. The inner cavity 11h of the blood vessel model 11 may contain a liquid L such as pseudo blood that simulates blood, water, or physiological saline.

A material constituting the blood vessel model 11 is not particularly limited as long as the material has a texture (flexibility, strength, etc.) similar to that of the blood vessel to be simulated. Examples of the material include gelled silicone, gelled polyvinyl alcohol, and gelled urethane. The hardness of the blood vessel model 11 may be adjusted by, for example, adjusting the content of water contained in the gelled material or combining a plurality of materials. The blood vessel model 11 can be formed by using a known technique.

The inner cavity 11h of the blood vessel model 11 may contain a liquid with a higher pressure than pressure on an outer peripheral surface of the blood vessel model 11. Namely, the pressure of the liquid L in the blood vessel model 11 may be set to a pressure higher than the atmospheric pressure (1 atm). In this case, for example, when a puncture hole occurs in the blood vessel model 11 for some reason, it is possible to cause the liquid L (pseudo-bleed) to leak from the blood vessel model 11 to the outside through the puncture hole in the same manner as the actual blood vessel. In addition, the presence or absence of leakage of the liquid L may be confirmed by observing the pressure of the liquid L.

The tissue model 21 is a site that is arranged around the blood vessel model 11 and simulates a tissue around a blood vessel.

The tissue model 21 may simulate, for example, a muscle.

Examples of a material constituting the tissue model 21 include a hydrogel acquired by mixing a polymer material such as polyvinyl alcohol, poly (meth) acrylate, or polyvinylpyrrolidone with a liquid such as water or a pseudo body fluid and causing the mixture to turn into a gel. Note that the texture (touch, hardness, etc.) similar to that of the tissue to be simulated may be adjusted by appropriately selecting a type of the polymer material and a mixing ratio with liquid.

The plurality of bubbles 31 include a bubble group including two or more bubbles 311 (hereinafter, the plurality of bubbles are collectively referred to as a “bubble group 31”). The bubble group 31 is dispersedly arranged between a surface of the tissue model 21 (an outermost surface s of the human body model 1) and the blood vessel model 11. In the human body model 1, the bubble group 31 is arranged in the vicinity of the surface of the tissue model 21.

An acoustic impedance of gas contained in the bubble 311 is different from an acoustic impedance of the tissue model 21 around the bubble 311. Due to this difference, an interface that reflects ultrasonic waves is formed at the boundary between the bubble 311 and the tissue model 21. Therefore, a part of ultrasonic waves incident through the outermost surface s of the human body model 1 is reflected by the interface, and ultrasonic waves reaching the deep portion beyond the bubble group 31 can be weakened. As a result, the echo image of the tissue model 21 between the bubble group 31 and the blood vessel model 11, which is displayed on the monitor of the ultrasonic image diagnostic apparatus, does not become too white (bright), and becomes an image that more closely resembles a human body.

A size and size distribution of each of the bubbles 311, and a density of the bubbles 311 in the bubble group 31 are not particularly limited as long as effects of the disclosed embodiments are not impaired. These may be determined depending on, for example, a size of the human body model 1 and a type of tissue to be simulated.

A site where the bubble group 31 is arranged may be any site between the surface of the tissue model 21 and the blood vessel model 11. The site may be, for example, a site adjacent to the surface of the tissue model 21 (the outermost surface s of the human body model 1) or a site adjacent to the blood vessel model 11.

Examples of gas contained in the bubble 311 include air, oxygen, nitrogen, and an inert gas such as argon. Of these, air is desirable.

As illustrated in FIG. 1, it is desirable that the plurality of bubbles 31 are dispersedly arranged along a surface direction of the outermost surface s of the human body model 1. For example, the bubble group 31 may be arranged in layers in such a way as to be positioned substantially parallel to the outermost surface s of the human body model 1. Note that each of the bubbles 311 included in the bubble group 31 is not necessarily aligned in a specific direction. Accordingly, it is possible to weaken ultrasonic waves reaching the deep portion over the surface direction of the human body model 1.

Next, a usage mode of the human body model will be described.

Herein, a procedure (EVUS guide) of performing therapy while inserting a guide wire into the blood vessel model 11 of the human body model 1 by using an ultrasonic image diagnostic apparatus will be exemplified.

When the human body model 1 is used, first, pseudo blood or the like is injected into the blood vessel model 11. To be specific, pseudo blood is injected into the inner cavity 11h by using a pump while measuring pressures. The above-described pressure may be set to a value at which pseudo blood or the like leaks from the blood vessel model at the time of being punctured. The pressure may be changed in a pulsating manner.

Next, using an ultrasonic image diagnostic apparatus, an ultrasonic probe is pressed against the outermost surface s of the human body model 1, and an echo image of the human body model 1 is displayed on a monitor while irradiating ultrasonic waves. Next, a guide wire is inserted into the inner cavity 11h of the blood vessel model 11. Specifically, a guide wire is inserted into the inner cavity 11h of the blood vessel model 11 via a connector, and then the distal end portion of the guide wire is pushed forward to a site to be treated while viewing a monitor.

Herein, since an acoustic impedance of the guide wire and an acoustic impedance of the blood vessel model 11 are different from each other, the guide wire advancing through the inner cavity 11h is displayed on a monitor screen. Therefore, even when the guide wire enters an unintended branch vessel at the branch portion of the blood vessel model 11, the state can be confirmed on the monitor, and the guide wire can be pushed forward to a desired site while correcting the procedure.

In addition, the ultrasonic waves reaching the deep portion of the tissue model 21 are weakened by the plurality of bubbles 31, and the acoustic impedances of the blood vessel model 11 and the tissue model 21 are also different from each other.

Therefore, the tissue model 21 in which whiteness (brightness) due to the ultrasonic waves is suppressed, and the blood vessel model 11 having an acoustic impedance different from that of the tissue model 21 is displayed on the monitor in such a way as to be distinguished from each other. As a result, even when the guide wire penetrates the blood vessel model 11, the state can be confirmed on the monitor.

As described above, since the human body model 1 has the above-described configuration, for example, when EVUS guide is performed, a part of ultrasonic waves incident through the outermost surface s can be reflected on the surface of each of the bubbles 311 included in the bubble group 31. Therefore, it is possible to weaken the ultrasonic waves reaching the deep portion beyond the bubble group 31, and it is possible to acquire the echo image of the deep portion that more closely resembles the human body.

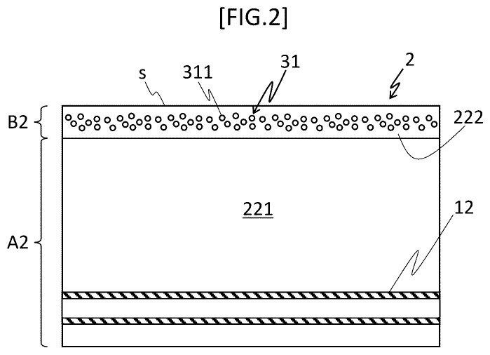

FIG. 2 is a schematic sectional view illustrating an embodiment of the disclosed embodiments. As illustrated in FIG. 2, a human body model 2 schematically includes a lower layer A2 and an upper layer B2. A usage mode of the human body model 2 is the same as that in the human body model 1.

The lower layer A2 is a site including a blood vessel model 12 and a first tissue model 221. The blood vessel model 12 is a site that simulates a blood vessel of a human body. The first tissue model 221 is a site which is arranged around the blood vessel model 12 and simulates a tissue around a blood vessel. The blood vessel model 12 and the first tissue model 221 may be the same as the blood vessel model 11 and the tissue model 21 described in the human body model 1, respectively.

The upper layer B2 is provided on the lower layer A2, and is a site including a second tissue model 222. The second tissue model 222 may be, for example, one that simulates a skin or the like.

Examples of a material constituting the second tissue model 222 include a hydrogel acquired by mixing a polymer material such as silicone, urethane, polyvinyl alcohol, poly (meth) acrylate, or polyvinylpyrrolidone with a liquid such as water or a pseudo body fluid and causing the mixture to turn into a gel. Note that the texture (touch, hardness, etc.) similar to that of the tissue to be simulated may be adjusted by appropriately selecting a type of the polymer material and a mixing ratio with liquid.

The material constituting the second tissue model 222 may be the same as or different from the material of the first tissue model 221. When the materials are different from each other, the acoustic impedances of the first tissue model 221 and the second tissue model 222 may be made different from each other in such a way that the both can be distinguished from each other on the monitor.

In the human body model 2, a plurality of bubbles 31 are dispersedly arranged inside the upper layer B2 along a surface direction of an outermost surfaces s of the human body model 2. A plurality of bubbles 31 (a bubble group 31) are the same as those in the human body model 1, and thus are denoted by the same reference numerals.

As described above, since the human body model 2 has the above-described configuration, for example, when EVUS guide is performed, a part of ultrasonic waves incident through the outermost surface s can be reflected on a surface of each bubble 311 included in the bubble group 31. Therefore, it is possible to weaken ultrasonic waves reaching the deep portion beyond the bubble group 31, and it is possible to acquire an echo image of a deep portion that more closely resembles the human body.

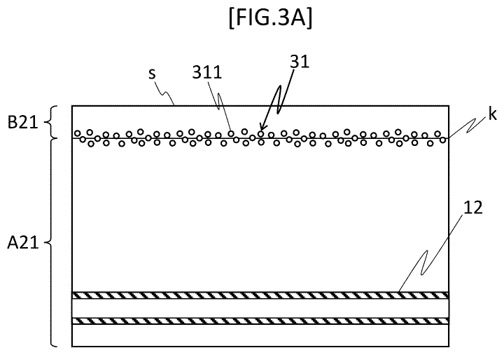

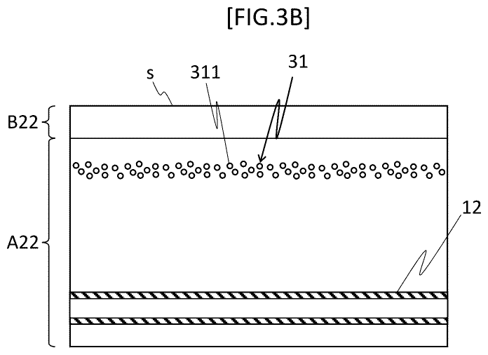

In the above-described embodiment, the human body model 2 in which the plurality of bubbles 31 are dispersedly arranged inside the upper layer B2 has been described. However, the plurality of bubbles 31 may be dispersedly arranged in a boundary portion k between an upper layer B21 and a lower layer A21 (see FIG. 3A), inside the lower layer A22 (see FIG. 3B), or at a site combining these.

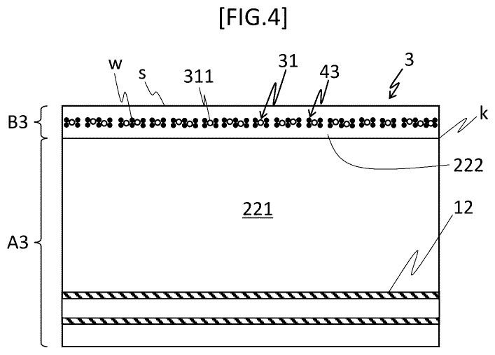

FIG. 4 is a schematic sectional view illustrating an embodiment of the disclosed embodiments. As illustrated in FIG. 4, a human body model 3 schematically includes a lower layer A3 and an upper layer B3. The human body model 3 is different from that of the human body model 2 in that it includes the upper layer B3. Note that the lower layer A3 has the same configuration as the lower layer A2 described above. A second tissue model 222 is the same as that in the human body model 2, and a plurality of bubbles 31 (a bubble group 31) are the same as those in the human body model 1, and thus are denoted by the same reference numerals. A usage mode of the human body model 3 is the same as that in the human body model 1.

The upper layer B3 is provided on the lower layer A3, and is a site including a second tissue model 222.

In the human body model 3, a mesh sheet 43 in which a wire w is braided is provided. The wire w extends along a face of the mesh sheet 43. The plurality of bubbles 31 are held between the wires of the mesh sheet 43. For example, each bubble 311 may be arranged separately in each gap between the wires w and w of the mesh sheet 43 braided in a lattice shape.

The mesh sheet 43 of the human body model 3 is arranged inside the upper layer B3, and is arranged inside the second tissue model 222 in such a way that the face thereof is substantially parallel to an outermost surface s of the human body model 3.

As the wire w constituting the mesh sheet 43, one or a plurality of solid wires or one or a plurality of twisted wires can be used. Note that the solid wire refers to one single wire and the twisted wire refers to a bundled group of wires formed by twisting together a plurality of single wires in advance.

Examples of the wire w include a natural fiber, a chemical fiber, and a metal wire. Examples of the natural fiber include a plant fiber and an animal fiber. Examples of a material of the plant fiber include cotton, hemp, pulp, and bamboo. Examples of a material of the animal fiber include silk and wool. Examples of the chemical fiber include a regenerated fiber, a semisynthetic fiber, and a synthetic fiber. Examples of a material of the regenerated fiber include rayon, cupra, and polynosic. Examples of a material of the semisynthetic fiber include acetate, triacetate, and promix. Examples of a material of the synthetic fiber include acrylic, polyester, polyamide, and urethane. Examples of a material of the metal wire include steel such as stainless steel and carbon steel, copper, and aluminum. As the wire w, a synthetic fiber such as polyamide may be conveniently used.

A wire diameter of the wire w, a size of an opening (gap) between the adjacent wires w and w, and a thickness of the mesh sheet 43 can be appropriately selected depending on a size of the bubble 311 held between the wires w and w, a total volume of the bubbles 311, a density of the bubbles 311, and the like.

As described above, since the human body model 3 has the above-described configuration, each of the bubbles 311 can be reliably held in the gap between the wires w and w of the mesh sheet 43. Therefore, ultrasonic waves reaching a deep portion beyond the mesh sheet 43 can be weakened, and the echo image of the deep portion that more closely resembles the human body can be acquired.

In the human body model 3, the mesh sheet 43 is arranged inside the upper layer B3. However, the mesh sheet 43 may be arranged at a boundary portion k between the upper layer B3 and the lower layer A3, inside the lower layer A3, or at a site combining these.

Further, the human body model may include a nonwoven fabric in which bubbles are held in gaps between adjacent fibers, instead of the mesh sheet 43 or together with the mesh sheet 43.

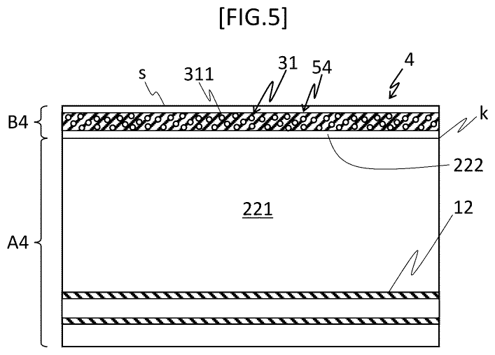

FIG. 5 is a schematic sectional view illustrating an embodiment of the disclosed embodiments. As illustrated in FIG. 5, a human body model 4 schematically includes a lower layer A4 and an upper layer B4. The human body model 4 is different from that of the human body model 3 in that it includes the upper layer B4. Note that the lower layer A4 has the same configuration as the lower layer A2 described above. A second tissue model 222 is the same as that in the human body model 2, and a plurality of bubbles 31 (a bubble group 31) are the same as those in the human body model 1, and thus are denoted by the same reference numerals. A usage mode of the human body model 4 is the same as that in the human body model 1.

The upper layer B4 is provided on the lower layer A4, and is a site including a second tissue model 222.

In the human body model 4, a resin sheet 54 is provided, and the plurality of bubbles 31 are held inside the resin sheet 54. For example, bubbles 311 may be uniformly and evenly dispersed and arranged inside the resin sheet 54.

The resin sheet 54 of the human body model 4 is arranged inside the upper layer B4, and is arranged inside the second tissue model 222 in such a way that a face of the resin sheet 54 is substantially parallel to an outermost surface s of the human body model 4.

As a material for forming the resin sheet 54, for example, a material acquired by gelling silicone, urethane, and polyvinyl alcohol may be exemplified from the viewpoint of a difference in acoustic impedance from a first tissue model 221 or bubbles 311.

A thickness of the resin sheet 54 can be appropriately selected depending on a size of the bubble 311 held therein, a total volume of the bubbles 311, a density of the bubbles 311, and the like.

As described above, since the human body model 4 has the above-described configuration, each of the bubbles 311 can be reliably held inside the resin sheet 54. Therefore, ultrasonic waves reaching a deep portion beyond the resin sheet 54 can be weakened, and an echo image of the deep portion that more closely resembles the human body can be acquired.

In the human body model 4, the resin sheet 54 is arranged inside the upper layer B4. However, the resin sheet 54 may be arranged at a boundary portion k between the upper layer B4 and the lower layer A4, inside the lower layer A4, or at a site combining these.

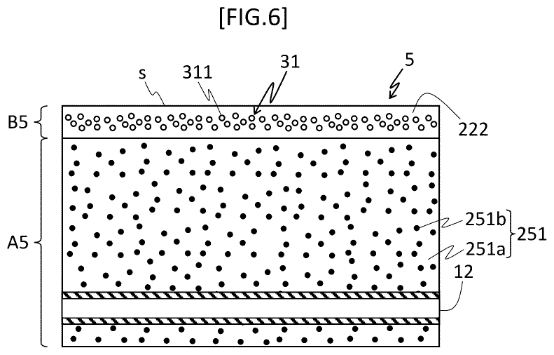

FIG. 6 is a schematic sectional view illustrating an embodiment of the disclosed embodiments. As illustrated in FIG. 6, a human body model 5 schematically includes a lower layer A5 and an upper layer B5. The human body model 5 is different from that of the human body model 2 in that it includes the lower layer A5. The upper layer B5 has the same configuration as the upper layer B2 described above. A usage mode of the human body model 5 is the same as that in the human body model 1.

The lower layer A5 is a site including a blood vessel model 12 and a first tissue model 251.

The blood vessel model 12 is a site that simulates a blood vessel of a human body. As the blood vessel model 12, a model similar to the blood vessel model 11 described in the human body model 1 can be exemplified.

The first tissue model 251 includes a resin material 251a and fine particles 251b. As the resin material 251a, a material similar to the material constituting the tissue model 21 described in the human body model 1 can be exemplified. As the resin material 251a, a urethane-based rubber, a silicone-based rubber, a styrene-based rubber, or the like may be used.

The fine particles 251b have an acoustic impedance different from that of the resin material 251a. The fine particles 251b may be, for example, evenly and uniformly dispersed in the resin material 251a in such a way that ultrasonic waves can be uniformly reflected inside the lower layer A5.

Examples of a material for forming the fine particles 251b include a resin material, a metal material, a ceramic material, and carbon. Examples of the resin material include polypropylene. Examples of the metal material include tungsten. Examples of the ceramic material include glass, bismuth oxide, barium sulfate, and aluminum oxide. These fine particles 251b may be, for example, in a fibrous form of resin fibers such as carbon fibers, glass fibers, cellulose nanofibers, and chitosan nanofibers.

A particle diameter and a particle size distribution of the fine particles 251b, and a dispersion density of the fine particles 251b are not particularly limited as long as the effects of the disclosed embodiments are not impaired. These may be determined depending on, for example, a size of the human body model 5 and a type of tissue to be simulated.

As described above, since the human body model 5 has the above-described configuration, for example, it is possible to accurately identify positions of the first tissue model 251 and the blood vessel model 12 by capturing an echo of ultrasonic waves reflected at the interface between the resin material 251a and the fine particles 251b.

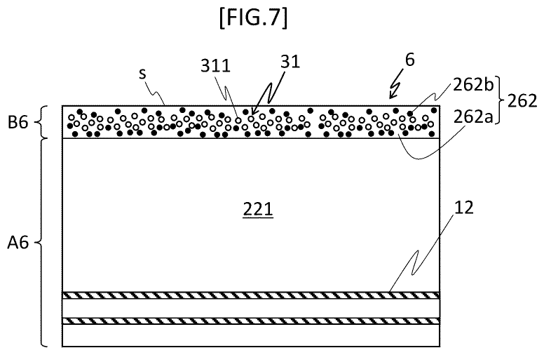

FIG. 7 is a schematic sectional view illustrating an embodiment of the disclosed embodiments. As illustrated in FIG. 7, a human body model 6 schematically includes a lower layer A6 and an upper layer B6. The human body model 6 is different from that of the human body model 2 in that it includes the upper layer B6. The lower layer A6 has the same configuration as the lower layer A2 described above. A usage mode of the human body model 6 is the same as that in the human body model 1.

The upper layer B6 is provided on the lower layer A6, and is a site including a second tissue model 262. The second tissue model 262 of the human body model 6 includes a resin material 262a and fine particles 262b. As the resin material 262a, a material similar to the material constituting the tissue model 21 described in the human body model 1 can be exemplified.

The fine particles 262b are particles having an acoustic impedance different from that of the resin material 262a. The fine particles 262b may be, for example, evenly and uniformly dispersed in the resin material 262a in such a way that ultrasonic waves can be uniformly reflected in the upper layer B6.

As a material forming the fine particles 262b and a form thereof, for example, those similar to the fine particles 251b described in the human body model 5 can be exemplified.

A particle diameter and a particle size distribution of the fine particles 262b, and a dispersion density of the fine particles 262b are not particularly limited as long as the effects of the disclosed embodiments are not impaired. These may be determined depending on, for example, a size of the human body model 6 and a type of tissue to be simulated.

As described above, since the human body model 6 has the above-described configuration, for example, it is possible to accurately identify a position of the second tissue model 262 by capturing an echo of ultrasonic waves reflected at the interface between the resin material 262a and the fine particles 262b.

Note that the present disclosure is not limited to the configurations of the embodiments described above, but is defined by the scope of claims, and is intended to include all modifications within the meaning and scope equivalent to the scope of claims. A part of the configurations of the above-described embodiments may be deleted or replaced with another configuration, and other configurations may be added to the configurations of the above-described embodiments.

For example, in the human body model 1 described above, the plurality of bubbles 31 are directly dispersed and arranged inside the tissue model 21 has been described. However, the plurality of bubbles 31 may be held between the wires of the mesh sheet as illustrated in the human body model 3, or may be held inside the resin sheet as illustrated in the human body model 4. In such a case, the mesh sheet or the resin sheet may be arranged at any site between the surface of the tissue model and the blood vessel model.

Further, in the human body model 5 described above, the fine particles 251b are included only in the lower layer A5, and in the human body model 6 described above, the fine particles 262b are included only in the upper layer B6. However, the human body model may include fine particles in both the lower layer and the upper layer.

In addition, when the EVUS guide is performed by using the above-described human body models 1 to 6, it is possible to acquire an ultrasonic echo image of a deep portion that more closely resembles a human body. Therefore, by using the human body model of the present disclosure, an operator can experience an EVUS guide similar to that used for a human body, or can perform training of the EVUS guide (for example, training of puncture for blood collection or drug injection) before using the EVUS guide for a patient.

The present disclosure includes the following human body models.

(1) A human body model including: a blood vessel model that simulates a blood vessel of a human body; and a tissue model that is arranged around the blood vessel model and that simulates a tissue around the blood vessel, in which a plurality of bubbles are dispersedly arranged between a surface of the tissue model and the blood vessel model.

(2) A human body model including: a lower layer including a blood vessel model that simulates a blood vessel of a human body and a first tissue model that is arranged around the blood vessel model and that simulates a tissue around the blood vessel; and an upper layer provided on the lower layer and including a second tissue model, in which a plurality of bubbles are dispersedly arranged in at least one of an inside of the upper layer, a boundary portion between the upper layer and the lower layer, and an inside of the lower layer.

(3) The human body model according to (2), in which the first tissue model includes a resin material and fine particles having an acoustic impedance different from an acoustic impedance of the resin material.

(4) The human body model according to (2), in which the second tissue model includes a resin material and fine particles having an acoustic impedance different from an acoustic impedance of the resin material.

(5) The human body model according to any one of (1) to (4), including a mesh sheet in which wires are braided, in which the plurality of bubbles are held between the wires of the mesh sheet.

(6) The human body model according to any one of (1) to (4), including a resin sheet, in which the plurality of bubbles are held inside the resin sheet.

(7) The human body model according to any one of (1) to (6), in which the plurality of bubbles are dispersedly arranged along a surface direction of an outermost surface of the human body model.

1. A human body model comprising:
a blood vessel model simulating a blood vessel of a human body; and
a tissue model disposed around the blood vessel model and simulating a tissue around the blood vessel, wherein
a plurality of bubbles is dispersed between a surface of the tissue model and the blood vessel model.

2. A human body model comprising:
a lower layer including a blood vessel model simulating a blood vessel of a human body and a first tissue model disposed around the blood vessel model and simulating a tissue around the blood vessel; and
an upper layer disposed on the lower layer, the upper layer including a second tissue model, wherein
a plurality of bubbles is dispersed in at least one of an inside of the upper layer, a boundary portion between the upper layer and the lower layer, and an inside of the lower layer.

3. The human body model according to claim 2, wherein the first tissue model includes a resin material and fine particles, the fine particles having an acoustic impedance different from an acoustic impedance of the resin material.

4. The human body model according to claim 2, wherein the second tissue model includes a resin material and fine particles, the fine particles having an acoustic impedance different from an acoustic impedance of the resin material.

5. The human body model according to claim 1, comprising a mesh sheet in which wires are braided, wherein the plurality of bubbles is held between the wires of the mesh sheet.

6. The human body model according to claim 1, comprising a resin sheet, wherein the plurality of bubbles is held inside the resin sheet.

7. The human body model according to claim 1, wherein the plurality of bubbles is dispersed along a direction of the surface of the tissue model.

8. The human body model according to claim 2, wherein the first tissue model includes a resin material and a plurality of fine particles dispersed in the resin material.

9. The human body model according to claim 2, wherein the second tissue model includes a resin material and a plurality of fine particles dispersed in the resin material.

10. The human body model according to claim 9, wherein the first tissue model includes another resin material and another plurality of fine particles dispersed in the other resin material.

11. The human body model according to claim 8, wherein the plurality of fine particles has an acoustic impedance different from that of the resin material.

12. The human body model according to claim 8, wherein the plurality of fine particles is uniformly dispersed in the resin material.

13. The human body model according to claim 8, wherein a particle size diameter of at least some particles of the plurality of fine particles is based on at least one of a size of the human body model and a type of the tissue.

14. The human body model according to claim 8, wherein at least one of a particle size distribution and a dispersion density of at least some particles of the plurality of fine particles is based on at least one of a size of the human body model and a type of the tissue.

15. The human body model according to claim 2, comprising a mesh sheet in which wires are braided, wherein the plurality of bubbles is held between the wires of the mesh sheet.

16. The human body model according to claim 2, comprising a resin sheet, wherein the plurality of bubbles is held inside the resin sheet.

17. The human body model according to claim 2, wherein the plurality of bubbles is dispersed along a direction of a surface of the second tissue model.
